(19) United States
(12) Patent Application Publication
(10) Pub. No.: US 2023/0364815 A1
(43) Pub. Date: Nov. 16, 2023

(54) RAZOR CARTRIDGE

(71) Applicant: DORCO CO., LTD., Gyeonggi-do (KR)

(72) Inventors: Woo Gyeong GO; Da Woon HAN, Seoul (KR)

(73) Assignee: DORCO CO., LTD., Gyeonggi-do (KR)

(21) Appl. No.: 18/043,270

(22) PCT Filed: Aug. 24, 2021
(86) PCT No.: PCT/KR2021/011284

§ 371 Date: Feb. 27, 2023

(30) Foreign Application Priority Data
Aug. 27, 2020 (KR) 10-2020-0108470
Jul. 26, 2021 (KR) 10-2021-0097754

(51) Int. Cl. B26B 21/22; B26B 21/40; B26B 21/44

(52) U.S. Cl. CPC B26B 21/222; B26B 21/4018; B26B 21/4025; B26B 21/44

(57) ABSTRACT

A razor cartridge is disclosed. According to an embodiment of the present disclosure, a razor cartridge is provided, the razor cartridge including at least one shaving blade having a cutting edge extending in a longitudinal direction; an upper surface on which the cutting edge is exposed; a bottom surface opposite the upper surface; and a pair of opening portions formed to penetrate the bottom surface from the upper surface in both side areas in the longitudinal direction.

### TECHNICAL FIELD

The present disclosure relates to a razor cartridge. More specifically, the present disclosure relates to a razor cartridge including an opening portion.

### BACKGROUND ART

Contents described in this section simply provide background information for the present disclosure and do not constitute prior art.

A conventional razor assembly, commonly known as a wet razor, includes a razor cartridge and a razor handle, and the razor cartridge includes a blade housing accommodating at least one shaving blade.

Meanwhile, since the razor cartridge is generally used multiple times, the razor cartridge needs periodic cleaning. To clean the razor cartridge, a method of immersing the entire cartridge in water and shaking the cartridge to discharge shaving residue or a method of washing the front or back of the cartridge under running water is used.

However, existing razor cartridges have a problem in that shaving residues existing on a surface of the cartridge and inside the cartridge are difficult to properly discharge due to narrow gaps between shaving blades and a complex structure of the cartridge.

In addition, when using a wet razor, a frictional force generated between the blade housing and the skin, a cutting force applied to body hair to cut the body hair, and irritation to a skin region with a wound may cause discomfort to the user.

In order to reduce the inconvenience, conventionally, shaving aids such as shaving foam, shaving gel, and shaving cream have been used during shaving. These shaving aids contain a lubricating component and can be applied to a skin of a user.

However, since wet razors are generally used with moisture, the shaving aid applied to the skin of a user may be washed out of the razor cartridge by moisture during shaving. In this case, shaving aid that has not yet been used or can be reused can also be washed away by the moisture. Therefore, there is a problem in that the applied shaving aid does not fulfill the function and is wasted, or too much shaving aid is used for one shave.

### DISCLOSURE

### Technical Problem

Accordingly, the present disclosure is to solve these problems, and a main purpose of the present disclosure is to provide a razor cartridge that can reduce waste of shaving aid and provide softness for a long time when shaving while having excellent washability.

### Technical Solution

According to an embodiment of the present disclosure to achieve such objectives, a razor cartridge is provided, the razor cartridge including at least one shaving blade having a cutting edge extending in a longitudinal direction; an upper surface on which the cutting edge is exposed; a bottom surface opposite the upper surface; and a pair of opening portions formed to penetrate the bottom surface from the upper surface in both side areas in the longitudinal direction.

### Advantageous Effects

As described above, according to the present embodiment, there is an effect of providing excellent washability, reducing waste of shaving aid, and providing softness for a long-time during shaving.

### BRIEF DESCRIPTION OF DRAWINGS

FIG. 1 is a front view of a razor cartridge according to a first embodiment of the present disclosure.

FIG. 2 is a cross-sectional view of the razor cartridge according to the first embodiment of the present disclosure, taken in a direction A-A′ of FIG. 1.

FIG. 3 is a cross-sectional view of the razor cartridge according to the first embodiment of the present disclosure, taken in a direction B-B′ of FIG. 1.

FIG. 4 is a cross-sectional view of the razor cartridge according to the first embodiment of the present disclosure, taken in a direction C-C′ of FIG. 1.

FIG. 5 is a front view of a razor cartridge according to a second embodiment of the present disclosure.

FIG. 6 is a side view of the razor cartridge according to the second embodiment of the present disclosure.

FIG. 7 is cross-sectional view of the razor cartridge according to the second embodiment of the present disclosure, taken in a direction D-D′ of FIG. 5.

FIG. 8 is a front view of a razor cartridge according to a third embodiment of the present disclosure.

FIG. 9 is a front view of a razor cartridge according to a fourth embodiment of the present disclosure.

### DETAILED DESCRIPTION

Hereinafter, some exemplary embodiments of the present disclosure will be described in detail with reference to the accompanying drawings. In the following description, like reference numerals designate like elements, although the elements are shown in different drawings. Further, in the following description of some embodiments, a detailed description of known functions and configurations incorporated therein will be omitted for the purpose of clarity and for brevity.

Additionally, various terms such as first, second, A, B, A, B, etc., are used solely to differentiate one component from the other but not to imply or suggest the substances, order, or sequence of the components. Throughout this specification, when a part ‘includes’ or ‘comprises’ a component, the part is meant to further include other components, not to exclude thereof unless specifically stated to the contrary.

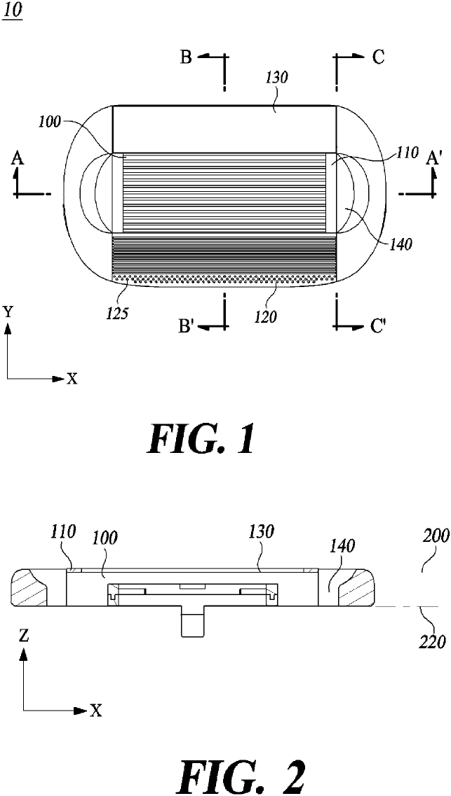

FIG. 1 is a front view of a razor cartridge 10 according to a first embodiment of the present disclosure.

FIG. 2 is a cross-sectional view of the razor cartridge 10 according to the first embodiment of the present disclosure, taken in a direction A-A′ of FIG. 1.

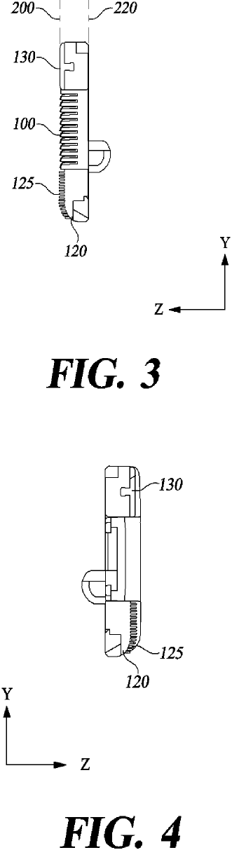

FIG. 3 is a cross-sectional view of the razor cartridge 10 according to the first embodiment of the present disclosure, taken in a direction B-B′ of FIG. 1.

FIG. 4 is a cross-sectional view of the razor cartridge 10 according to the first embodiment of the present disclosure, taken in a direction C-C′ of FIG. 1.

Referring to FIGS. 1 to 4, the razor cartridge 10 according to the first embodiment of the present disclosure includes all or some of a shaving blade 100, a guard portion 120, a cap portion 130, and an opening portion 140.

The shaving blade 100 includes a cutting edge extending in a longitudinal direction, and may include at least one cutting edge, that is, one or a plurality of cutting edges. Here, the longitudinal direction refers to a width direction of the shaving blade 100, and a transverse direction refers to a direction perpendicular to the longitudinal direction and parallel to a shaving direction. For example, in FIG. 1, the longitudinal direction is a direction parallel to an X-axis, and the transverse direction is a direction parallel to a Y-axis. Therefore, the razor cartridge 10 may be configured such that one or the plurality of shaving blades 100 are placed in the longitudinal direction.

The cutting edge is configured to cut body hair of a user during shaving, and when a plurality of shaving blades 100 are provided, a direction of the cutting edge of each blade may be formed in the same direction, but is not necessarily limited thereto.

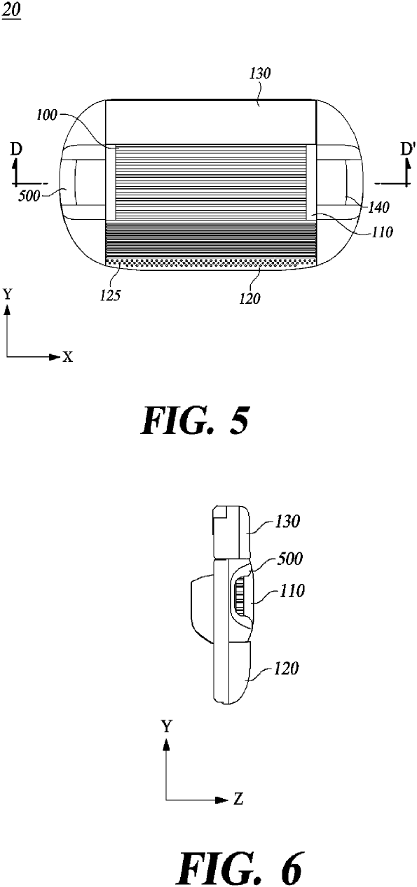

Meanwhile, in FIGS. 1 to 4, a shape of the cutting edge may be formed as a bent blade, but is not necessarily limited thereto, and may be formed as a flat blade or a welded blade. The same came be said for FIGS. 5 to 9.

In addition, the razor cartridge 10 may include a blade accommodating portion (not illustrated) for accommodating the shaving blade 100. The blade accommodating portion may be disposed as a pair on both side end parts in the longitudinal direction of the shaving blade 100, but is not necessarily limited thereto.

In addition, in order to prevent the shaving blade 100 from being separated from the razor cartridge 10, the razor cartridge 10 may include fixing clips 110 located on both side end parts of the shaving blade 100.

Since the fixing clip 110 fixes both sides of the shaving blade 100 to the razor cartridge 10, the shaving blade 100 may not be separated from the razor cartridge 10 during shaving. However, the present disclosure is not limited thereto, and for example, the shaving blade 100 may be fixed to the razor cartridge 10 without the fixing clip 110 by a frame covering a part of an upper side of the razor cartridge 10.

The guard portion 120 is disposed in front of the cutting edge of the shaving blade 100. Here, the front and rear of the shaving blade 100 are defined based on the shaving direction of the razor cartridge 10. Therefore, in FIG. 1, the front and rear of the shaving blade 100 are in a negative Y-axis direction and a positive Y-axis direction, respectively, with respect to the shaving blade 100. The guard portion 120 may stretch the skin before body hair is cut by the shaving blade 100 during shaving. Therefore, the body hair of the user can be erected in a direction perpendicular to a skin surface of the user by the guard portion 120, and cutting of the body hair by the shaving blade 100 can be made easier.

The guard portion 120 may include a plurality of guard protrusions 125 formed on one surface of the guard portion 120. The plurality of guard protrusions 125 may protrude from one surface of the guard portion 120 in a direction perpendicular to the upper side of the shaving blade 100, but is not necessarily limited to such a direction.

The guard protrusion 125 may have a cylindrical shape or a polygonal column shape, but is not necessarily limited thereto. For example, the plurality of guard protrusions 125 may have a shape extending in the transverse direction or the longitudinal direction. In addition, some of the plurality of guard protrusions 125 may have a column shape, and others may have a shape extending along the longitudinal direction or the transverse direction.

The plurality of guard protrusions 125 may be configured using an elastic material, and thus may provide a soft contact feeling and tension feeling to the skin of the user. However, the material of the plurality of guard protrusions 125 is not necessarily limited to an elastic material, and may be configured using a material other than an elastic material.

The cap portion 130 is disposed behind the cutting edge of the shaving blade 100. A lubricating strip may be disposed on the cap portion 130, and since the lubricating strip may contain a lubricating material, the lubricating strip may serve to protect the skin of the user during shaving. However, the lubricating strip does not necessarily have to be disposed on the cap portion 130, and may be disposed adjacent to the cap portion 130.

Meanwhile, the guard portion 120 and the cap portion 130 do not have to be disposed only in front of and behind the cutting edge of the shaving blade 100, respectively. For example, the guard portion 120 may be disposed in front of the cutting edge of the shaving blade 100 and also disposed behind the cutting edge of the shaving blade 100. Similarly, the cap portion 130 may also be disposed behind the cutting edge of the shaving blade 100 and in front of the cutting edge of the shaving blade 100.

When the guard portion 120 and the cap portion 130 are disposed in front of the cutting edge of the shaving blade 100 and the guard portion 120 and the cap portion 130 are disposed behind the cutting edge of the shaving blade 100, the front and rear order of the guard portion 120 and the cap portion 130 in each case can be easily changed according to the purpose and use.

The opening portion 140 is formed as a pair so as to penetrate a bottom surface 220 from an upper surface 200 in both side areas in the longitudinal direction of the razor cartridge 10. Here, the upper surface 200 refers to a surface on which the cutting edge of the shaving blade 100 is exposed, and the bottom surface 220 refers to a surface located opposite to the upper surface 200.

By penetrating the bottom surface 220 from the upper surface 200, the opening portion 140 may be configured so that rinsing water can pass through. Therefore, since the razor cartridge 10 includes the opening portion 140, shaving residue and foreign matter present in the razor cartridge 10 can be smoothly discharged.

Referring to FIG. 1, the opening portion 140 may be formed in a region adjacent to both side end parts in the longitudinal direction of the shaving blade 100. When the opening portion 140 is configured in this way, shaving residues existing between the surface of the razor cartridge 10 and the shaving blade 100 can be smoothly discharged. That is, when the front or rear surface of the cartridge is faced with running water for cleaning the cartridge, the water flows between the surface of the razor cartridge 10 and the shaving blade 100 and naturally passes through the opening portion 140, and thus, shaving residues can be discharged smoothly.

Referring to FIG. 2, the opening portion 140 may have a width that varies in a portion from the upper surface 200 to the bottom surface 220, and the other portion may have the same width, but is not necessarily limited thereto. For example, the opening portion 140 may be formed with the same width from the upper surface 200 to the bottom surface 220, or may be formed with a continuously changing width from the upper surface 200 to the bottom surface 220.

In order to further enhance the cleaning effect of shaving residues present between the shaving blades 100, the opening portion 140 may be formed to be in fluid communication with both side end parts in the longitudinal direction of the blade accommodating portion. For example, the blade accommodating portion may be in fluid communication with the opening portion 140 by forming holes on both sides in the longitudinal direction. In this case, the cleaning effect of the shaving residues present between the shaving blades 100 can be further enhanced by tilting the razor cartridge 10 and making the razor cartridge 10 face the running water.

However, the position of the opening portion 140 is not necessarily limited to regions adjacent to both side end parts in the longitudinal direction of the shaving blade 100 as illustrated in FIG. 1. For example, the opening portion 140 may be formed on both side end parts in the longitudinal direction of the razor cartridge 10. That is, the opening portion 140 may be formed at a position moved in a negative X-axis direction or a positive X-axis direction from the position of the opening portion 140 illustrated in FIG. 1.

In addition, the opening portion 140 may be formed in a region adjacent to both side end parts in the longitudinal direction of the cap portion 130, and may be formed in a region adjacent to both side end parts in the longitudinal direction of the guard portion 120.

The number of opening portions 140 may be two or more. That is, the opening portion 140 may be formed as a pair in the region adjacent to both side end parts in the longitudinal direction of the shaving blade 100, may be formed as a pair in the region adjacent to both side end parts in the longitudinal direction of the cap portion 130 may be formed, and may be formed as a pair in a region adjacent to both side end parts in the longitudinal direction of the guard portion 120.

However, the present disclosure is not necessarily limited thereto. For example, the opening portion 140 may extend from the region adjacent to both side end parts in the longitudinal direction of the shaving blade 100 to both side end parts in the longitudinal direction of the guard portion 120 and/or the cap portion 130 and may be formed as a pair.

When the opening portion 140 is configured as described above, shaving residue and foreign matter existing on the surface of the cap portion 130 and/or the guard portion 120 after the shaving can be smoothly discharged.

Meanwhile, the razor cartridge 10 may include a rubber portion (not illustrated) formed on the outside of the opening portion 140. The rubber portion may be configured to be deformable along a body surface using an elastic material. Therefore, since the rubber portion is formed on the outside of the opening portion 140 and can be deformed along the body surface, even when the outside of the opening portion 140 contacts the skin during the shaving, it is possible to provide a feeling of adhesion and softness to the skin, and pull the skin of the user.

The rubber portion may be formed on the outside of the opening portion 140 along a thickness direction of the razor cartridge 10. Here, the thickness direction may be a direction perpendicular to the upper surface 200 from the bottom surface 220.

In addition, the razor cartridge 10 may include a rubber support portion (not illustrated) arranged on a plane parallel to the bottom surface 220 and configured to support the bottom of the rubber portion. For example, the rubber support portion may be integrally formed with the razor cartridge 10, and the rubber portion may be coated and formed on the rubber support portion. In this case, the rubber portion and rubber support portion may be formed along the thickness direction of the razor cartridge 10.

The rubber support portion may be made of a plastic material, but is not necessarily limited thereto. In addition, as long as the rubber portion does not separate from the razor cartridge 10, the razor cartridge 10 does not necessarily have to include the rubber support portion. That is, the rubber portion may be formed along the thickness direction from the bottom surface 220 to the upper surface 200 without the rubber support portion.

The rubber portion may be formed to be connected to the guard portion 120. That is, the rubber portion may be integrally formed with the guard portion 120 by using the same material as the guard portion 120. In this case, since even the rubber portion can be integrally manufactured in the process of manufacturing the guard portion 120, manufacturing convenience can be increased. Moreover, it is possible to prevent the rubber portion from being separated from the razor cartridge 10.

Meanwhile, the razor cartridge 10 may be mounted on a razor handle (not illustrated). The user may perform shaving by gripping the razor handle and bringing the razor cartridge 10 into contact with the skin. In this case, the razor cartridge 10 may be pivotally connected to the razor handle, but is not necessarily limited thereto.

For example, the razor cartridge 10 may be mounted on the razor handle so as to be replaceable, or may be mounted on the razor handle using a fixed type connector or a rotary type connector. In addition, one side of the razor cartridge 10 may be directly mounted on one side of the razor handle.

FIG. 5 is a front view of a razor cartridge 20 according to a second embodiment of the present disclosure.

FIG. 6 is a side view of the razor cartridge 20 according to the second embodiment of the present disclosure.

Referring to FIGS. 5 and 6, the razor cartridge 20 may include a pair of side wall portions 500 formed on at least a portion of both side end parts in a longitudinal direction. Here, an opening portion 140 may be formed between both side end parts in the longitudinal direction of a shaving blade 100 and the side wall portion 500. However, as illustrated in FIG. 5, when the razor cartridge 20 includes a fixing clip 110, the opening portion 140 may be formed between the fixing clip 110 and the side wall portion 500.

Meanwhile, the side wall portion 500 may be configured to extend from a bottom surface 220 toward an upper surface 200. Accordingly, the side wall portion 500 may be formed to have an uniform height from the bottom surface 220, but the side wall portion 500 does not necessarily have to extend to have an uniform height from the bottom surface 220. For example, referring to FIG. 6, heights of both ends of the side wall portion 500 may be greater than the height of the center of the side wall portion 500 in the Y-axis direction.

Meanwhile, a height of at least a portion of the side wall portion 500 may be smaller than a height between the bottom surface 220 and the upper surface 200. For example, the height of at least a portion of the side wall portion 500 may be formed to a height of 20% to 80% of the height between the bottom surface 220 and the upper surface 200 and, preferably, formed to a height of 40% to 60%. In this case, a step difference for the upper surface 200 may be formed on both sides of the razor cartridge 20 based on the X-axis direction of FIG. 5.

Herein, the region where the height of the side wall portion 500 is smaller than the height between the bottom surface 220 and the upper surface 200 is preferably a region adjacent to both side end parts in the longitudinal direction of the shaving blade 100 and/or the blade accommodating portion, but may be the entire region of both side end parts of the razor cartridge 20. In addition, when holes are formed on both sides of the longitudinal direction of the blade accommodating portion at least a portion of the side wall portion 500 is preferably formed at a position lower than the position where the blade accommodating portion is formed so as not to block the hole.

In this case, the opening portion 140 can not only penetrate the upper surface 200 and the bottom surface 220, but also both side end parts in the longitudinal direction of the blade accommodating portion and both side areas in the longitudinal direction of the razor cartridge 20. Therefore, the opening portion 140, the holes formed on both sides of the longitudinal direction of the blade accommodating portion, and an upper portion of the side wall portion 500 may be in fluid communication with each other.

Therefore, for example, the rinsing water introduced from the side wall portion 500 on one side in the longitudinal direction of the razor cartridge 20 may pass through the opening portion 140 on one side and the hole on one side, pass between the plurality of shaving blades 100, and may pass through the hole on the other side, the opening portion 140 on the other side, and the side wall portion 500 on the other side and be discharged along with the shaving residue.

However, the height of at least a portion of the side wall portion 500 does not necessarily have to be smaller than the height between the bottom surface 220 and the upper surface 200. For example, like the razor cartridge 10 of FIG. 2, the side wall portion 500 may be formed at the same height as the height from the bottom surface 220 to the upper side or upper surface 200 of the razor cartridge 20.

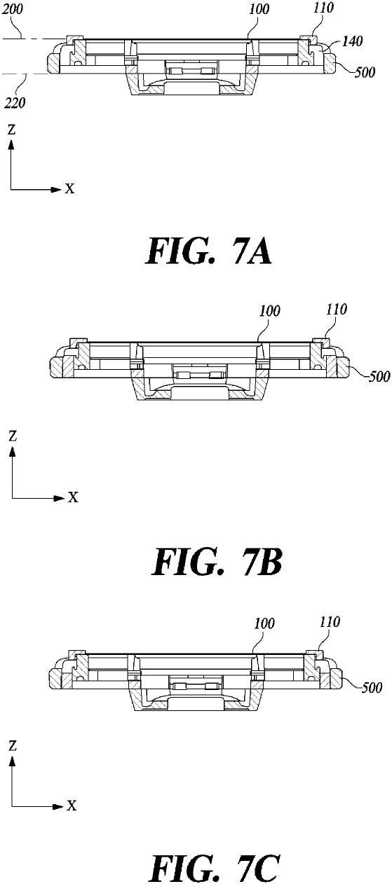

FIG. 7 is a cross-sectional view of the razor cartridge 20 according to the second embodiment of the present disclosure, taken in a direction D-D′ of FIG. 5.

FIG. 7A illustrates a case in which the opening portion 140 is formed to pass through the upper surface 200 and the bottom surface, as illustrated in FIGS. 5 and 6.

In this case, the rinsing water can pass between the upper surface 200 and the bottom surface 220 to be discharged to the top and bottom, as well as pass between one side and the other side in the longitudinal direction of the razor cartridge 20 to be discharged to one side and the other side. Accordingly, the shaving residues inside the razor cartridge 20 can be washed out more effectively.

However, the razor cartridge 20 does not necessarily have to be configured as illustrated in FIG. 7A. For example, in the razor cartridge 20, as illustrated in FIG. 7B and FIG. 7C, the opening portion 140 may not penetrate the upper surface 200 and the bottom surface 220, and both side areas of the razor cartridge 20 may be opened by a space between the upper surface 200 and the upper side of the stepped side wall portion 500 in the X-axis direction. Even in this case, since the holes formed on both sides in the longitudinal direction of the blade accommodating portion and the upper portion of the side wall portion 500 are in fluid communication, the rinsing water may pass between one side and the other side of the razor cartridge 20 and be discharged to one side and the other side.

In the above description, in the razor cartridge 20 according to the second embodiment of the present disclosure, components other than the side wall portion 500 may be the same as those of the razor cartridge 10 according to the first embodiment of the present disclosure, except for those specifically described, and thus a description thereof is omitted.

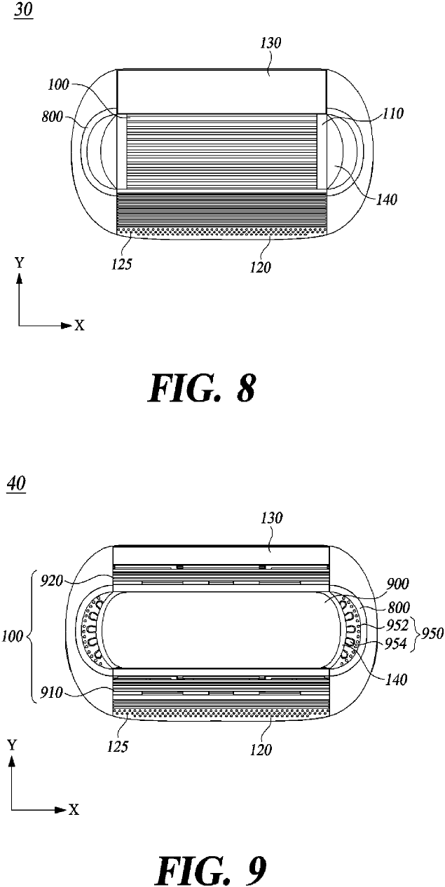

FIG. 8 is a front view of a razor cartridge 30 according to a third embodiment of the present disclosure.

Referring to FIG. 8, in the razor cartridge 30, an elastic coating portion 800 may be formed in at least a portion of at least one of a peripheral portion or an inner surface of an opening portion 140.

The elastic coating portion 800 may be formed using an elastic material, for example, a rubber material, but is not necessarily limited to a rubber material. When shaving, the elastic coating portion 800 may stretch the skin around which shaving is performed. For example, the user may perform shaving in a curved motion rather than a straight line. In this case, the body hair of the user may be raised in a direction perpendicular to the skin surface by the elastic coating portion 800, and thus, cutting of the body hair by the shaving blade 100 can be made easier.

Although only the elastic coating portion 800 is illustrated in FIG. 8, the razor cartridge 30 may further include the rubber portion outside the opening portion 140 even when the elastic coating portion 800 is formed.

In the above description, in the razor cartridge 30 according to the third embodiment of the present disclosure, since other components except for the elastic coating portion 800 may be the same as those of the razor cartridges 10 and 20 according to the first and second embodiments of the present disclosure, descriptions of other components are omitted.

FIG. 9 is a front view of a razor cartridge 40 according to a fourth embodiment of the present disclosure.

Referring to FIG. 9, a shaving blade 100 of the razor cartridge 40 may include at least one first shaving blade 910 having a cutting edge and at least one second shaving 920 blade having a cutting edge.

In this case, each of the first shaving blade 910 and the second shaving blade 920 may be one blade or a plurality of blades. When the first shaving blades 910 and the second shaving blades 920 are arranged as a plurality of blades, a distance between the plurality of first shaving blades 910 and a distance between the plurality of second shaving blades 920 may be the same, but are not necessarily limited thereto.

Meanwhile, a cutting edge direction of the first shaving blade 910 and a cutting edge direction of the second shaving blade 920 may be formed in the same direction. However, the present disclosure is not necessarily limited thereto, and each cutting edge direction may be formed in opposite directions to each other so that shaving can be performed regardless of the gripping direction or shaving direction of the razor.

In addition, the razor cartridge 40 may further include a lubricating member 900. The lubricating member 900 is configured to be positioned between the first shaving blade 910 and the second shaving blade 920. In addition, the lubricating member 900 is configured to apply a lubricating material to the skin of the user in order to assist in shaving and provide softness to the user. Accordingly, the lubricating member 900 may be in a solid including a lubricating material, and may be formed using a surfactant, such as soap.

Preferably, a length of the lubricating member 900 in the longitudinal direction is configured to be equal to or greater than lengths of the first shaving blade 910 and the second shaving blade 920 in the transverse direction, so that the lubricating member 900 can be applied in all sections in the transverse direction where the body hair is cut by the shaving blade. However, the present disclosure is not necessarily limited thereto.

Referring to FIG. 9, the opening portion 140 may be formed in a region adjacent to both side end parts in the longitudinal direction of the lubricating member 900, but as long as the rinsing water can pass through the razor cartridge 40, it is not necessarily limited thereto.

Meanwhile, a structure 950 may be formed on at least one of the peripheral portion or the inner surface of the opening portion 140. The structure 950 may be configured using a protrusion portion 952, a protuberance portion, a recess 954, a concave portion, or a combination of two or more thereof.

When the elastic coating portion 800 is formed in at least a portion of at least one of the peripheral portion or the inner surface of the opening portion 140, the structure 950 may be formed in the elastic coating portion 800, and similarly, may include the protrusion portion 952, the protuberance portion, the recess 954, the concave portion, or a combination of two or more thereof. The structure 950 may be made of the same material as the elastic coating portion 800, for example, a rubber material, so that even when the elastic coating portion 800 and the structure 950 come into contact with the skin during shaving, the structure provides a feeling of adhesion and softness to the skin. In addition, the structure 950 may be integrally formed with the elastic coating portion 800, but is not necessarily limited thereto.

The recess 954 and the concave portion may hold foam created during shaving by a shaving aid such as shaving foam, shaving gel, shaving cream, and the like. Therefore, it is possible to maintain the foam created by the shaving aid in the opening portion 140 for a long time.

The protrusion portion 952 and the protuberance portion serve to guide the foam created by the shaving aid toward the opening portion 140. That is, the protrusion portion 952 and the protuberance portion prevent foam created by the shaving aid from escaping the razor cartridge 40, and enable the foam to be continuously retained by the recess 954 and the concave portion. In addition, the protrusion portion 952 and the protuberance portion generate friction with the skin so that more abundant foam is created by the shaving aid and lubricating material. When each of the protrusion portion 952 and the protuberance portion are configured in plurality, foam created by the shaving aid and the lubricating material may be retained between each of the protrusion portions 952 and the protuberance portions.

Since the razor cartridge 40 includes the structure 950 as described above, it is possible to continuously provide softness to the user for a long time during shaving.

Meanwhile, the structure 950 may be formed as one or a plurality, and may be configured using an elastic material, but is not necessarily limited to an elastic material. When a plurality of structures 950 are formed, each structure 950 does not necessarily need to have the same shape.

For example, the protrusion portion 952 and the protuberance portion may have a cylindrical shape or polygonal column shape, and when the structure 950 is configured using a plurality of protrusion portions 952, some of the protrusion portions 952 may have a cylindrical shape, and other protrusion portions may have a polygonal column shape. Among the structures 950 having a cylindrical shape, the size of each cylinder may be different, and among the structures 950 having a polygonal column shape, the size of each polygonal column may be different. The shapes of the protrusion portion 952 and the protuberance portion are not necessarily limited to the cylindrical shape or polygonal column shape.

Similarly, the recess 954 and the concave portion may also have various shapes, and when the structure 950 includes a plurality of recesses 954, each of the recessed shapes of the recesses 954 may be different from each other, and depths of depressions may also be different from each other.

In addition, the structure 950 may be formed in at least one of the peripheral portion or the inner surface of the opening portion 140 of not only the razor cartridge 40 according to the fourth embodiment of the present disclosure but also the razor cartridges 10, 20, and 30 according to the first to third embodiments of the present disclosure.

Meanwhile, although only the elastic coating portion 800 is illustrated in FIG. 9, the razor cartridge 40 may include the rubber portion formed on the outside of the opening portion 140 even when the elastic coating portion 800 is formed.

The razor cartridge 40 includes the lubricating member 900, so that softness can be provided during shaving without a separate shaving aid. Meanwhile, in the razor cartridge 40, since the lubricating member 900 is positioned between the plurality of shaving blades 100, the lubricating material can be continuously applied to the skin of the user during the shaving, so the user can continuously obtain a smooth feeling when the shaving. In addition, since the lubricating member 900 is relatively located in the center of the razor cartridge 40, even when shaving a curved body part, such as an armpit, a chin, a neck, or the like, the application of the lubricating material can be easily performed.

In the above description, in the razor cartridge 40 according to the fourth embodiment of the present disclosure, since other components except for the first and second shaving blades 910 and 920, the lubricating member 900, and the structure 950 are the same as those of the razor cartridges 10, 20, and 30 according to the first to third embodiments of the present disclosure, descriptions of the components are omitted.

As described above, the razor cartridges 10, 20, 30, and 40 according to the embodiments of the present disclosure have excellent washability, can reduce waste of the shaving aid, and provide softness for a long-time during shaving.

Although exemplary embodiments of the present disclosure have been described for illustrative purposes, those skilled in the art will appreciate that various modifications, additions, and substitutions are possible, without departing from the idea and scope of the claimed invention. Therefore, exemplary embodiments of the present disclosure have been described for the sake of brevity and clarity. The scope of the technical idea of the present embodiments is not limited by the illustrations. Accordingly, one of ordinary skill would understand that the scope of the claimed invention is not to be limited by the above explicitly described embodiments but by the claims and equivalents thereof.

[Description of symbols] 10, 20, 30, 40: razor cartridge, 100: shaving blade, 110: fixing clip, 120: guard part, 125: guard protrusion, 130: cap part, 140: opening, 200: upper surface, 220 : bottom surface, 500: side wall part, 800: elastic coating part, 900: lubricating member, 910: first shaving blade, 920: second shaving blade, 950: structure, 952: protrusion, 954: recess

### CROSS-REFERENCE TO RELATED APPLICATION

This application claims priority to Patent Application No. 10-2020-0108470, filed on Aug. 27, 2020 in Korea, and Patent Application No. 10-2021-0097754, filed on Jul. 26, 2021 in Korea, the entire contents of which are incorporated herein by reference.

1] A razor cartridge comprising:
at least one shaving blade having a cutting edge extending in a longitudinal direction;
an upper surface on which the cutting edge is exposed;
a bottom surface opposite to the upper surface; and
a pair of opening portions formed to penetrate the bottom surface from the upper surface in both side areas in the longitudinal direction.

2] The razor cartridge of claim 1, wherein the opening portion is formed in a region adjacent to both side end parts in the longitudinal direction of the shaving blade.

3] The razor cartridge of claim 1, wherein the opening portion is formed on both side end parts in the longitudinal direction of the razor cartridge.

4] The razor cartridge of claim 1, further comprising a cap portion disposed behind the cutting edge,
wherein the opening portion is formed in a region adjacent to both side end parts in a longitudinal direction of the cap portion.

5] The razor cartridge of claim 1, further comprising a guard portion disposed in front of the cutting edge,
wherein the opening portion is formed in a region adjacent to both side end parts in a longitudinal direction of the guard portion.

6] The razor cartridge of claim 1, further comprising a pair of side wall portions formed in at least a part of both side end parts in the longitudinal direction,
wherein the opening portion is formed between the side wall portion and both side end parts in the longitudinal direction of the shaving blade.

7] The razor cartridge of claim 6, wherein the side wall portion extends from the bottom surface toward the upper surface, and a height of at least a portion of the side wall portion is smaller than a height between the bottom surface and the upper surface.

8] The razor cartridge of claim 1, further comprising a rubber portion formed outside the opening portion.

9] The razor cartridge of claim 8, wherein the rubber portion is formed along a thickness direction of the razor cartridge.

10] The razor cartridge of claim 9, further comprising a rubber support portion formed on a plane parallel to the bottom surface and configured to support the bottom of the rubber portion.

11] The razor cartridge of claim 8, further comprising a guard portion disposed in front of the cutting edge,
wherein the rubber portion is formed to be connected to the guard portion.

12] The razor cartridge of claim 1, wherein the opening portion is configured to allow rinsing water to pass through the opening portion.

13] The razor cartridge of claim 1, wherein a structure is formed on at least one of a peripheral portion or an inner surface of the opening portion, wherein the structure includes a protrusion portion, a protuberance portion, a recess, a concave portion, or a combination of two or more thereof.

14] The razor cartridge of claim 1, further comprising an elastic coating portion formed in at least a portion of at least one of a peripheral portion or an inner surface of the opening portion.

15] The razor cartridge of claim 14, wherein a structure is formed in the elastic coating portion, wherein the structure includes a protrusion portion, a protuberance portion, a recess, a concave portion, or a combination of two or more thereof.

16] The razor cartridge of claim 1, wherein the shaving blade includes at least one first shaving blade having a cutting edge and at least one second shaving blade having a cutting edge,
and wherein the razor cartridge further comprises a lubricating member positioned between the first shaving blade and the second shaving blade.
